(19) United States
(12) Patent Application Publication
(10) Pub. No.: US 2007/0270181 A1
(43) Pub. Date: Nov. 22, 2007

(54) Hybrid telephone system

(76) Inventor: Thomas Matthew Michaud, Chantilly, VA (US)

Correspondence Address: Thomas Michaud, 43399 Mountain View Drive, Chantilly, VA, 20152, US

(21) Appl. No.: 11/434,691

(22) Filed: May 16, 2006

(51) Int. Cl. H04B 1/40; H04M 1/00

(52) U.S. Cl. 455/552.1; 455/74.1

(57) ABSTRACT

A hybrid telephone system which links a user's cellular phone with a land line telephone system using radio frequencies. The hybrid telephone system will contain a radio frequency communication chips and a conversion chip to interface between the cellular phone and a land line telephone.

### BACKGROUND

Cellular converge varies greatly in quality though both rural areas and metropolitan areas. Hybrid systems, which utilize both land line and cellular telephones, have been developed because the problem still exists. These systems provide multiple telephone service at reduced cost. A major drawback of these hybrid systems involves dropped calls have been developed because these systems provide both. All systems are striving to reduce dead spots which result in dropped calls. The primary object of this invention is to provide a hybrid system which includes the convenience of multiple land line telephones which operate in conjunction with a cellular phone without the inconvenience of dead spots.

Another object of the invention is to provide economical voice communication in a convenient manner.

Another object of the invention is to provide multiple land line phones in communication with a signal cellular phone.

Another object of the invention is to provide an ideal stationary position for the cellular phone.

### SUMMARY OF INVENTION

A hybrid telephone system interfacing cellular and land line phone technologies for use primarily within a building such as a home or work place. The system includes a telephone network within the building which is comprised of land lines which extend though the building and are connected with land line telephones (LLT). The LLT are capable of sending and receiving analog signals. The system includes a cellular telephone (CT) which includes a first communication chip (first chip). The first chip is capable of sending and receiving radio frequency (RF) signals to and from the CT. The system provides for the CT to be mounted in a stationary location which provides a power source and external antenna.

A second communication chip (second chip) is located in the building in a spaced and separate location from that of the first chip. The second chip is capable of receiving and converting RF signals into digital data and sending the digital data. The second chip is also capable of receiving and converting digital data into RF signals and sending the converted RF signals.

A conversion chip (third chip) is connected with the second chip and the LLT. The third chip is operative to receive and convert digital data into analog signals and to receive and convert analog signals into digital data. The third chip receives analog signals from the LLT and sends digital data to the second chip or it receives digital data from the second chip and sends analog signals to the LLT.

The system operates to receive incoming calls to the cell phone which are converted into RF information by the first chip which is sent to the second chip and converted to digital data. The digital data is sent to the third chip and converted to analog data which is sent to the LLT.

Outgoing calls are initiated by the LLT which sends an analog signal to the third chip which converts the signal into digital data. The digital data is sent to the second chip which converts it to RF information. The second chip transmits the RF information to first chip. The first chip converts the RF information into CT commands and data which is transmitted.

The conversion chip is also operative to generate an analog signal representing a dial tone when the LLT is taken off hook. The conversion chip also is operative to convert analog signals of numerical designation into digital data of numerical designation and to transmit that digital data to the second chip. The second chip then connects the digital data into RF information and transmits that information to the first chip. The first chip converts the RF information into CT data which causes the CT to initiate a call.

The conversion chip also acts to sense the termination of a LLT call and to generate a digital data signal which passes through the second chip as radio frequency information to the first chip which deactivates the CT.

Independent power sources power the CT and first chip and second chip and conversion chip and the LLT.

### DESCRIPTION OF THE DRAWING

FIG. 1 is a diagrammatic view of the hybrid telephone system of the invention.

### DETAILED DESCRIPTION

A primary convenience of land line telephone (LLT) is the clarity of the call. Another advantage of LLT is the convenience of a plurality of telephone units located about the premises rather then having to carry a single telephone. Normally cellular telephones (CT) can not provided this convenience as each CT carries its own number.

Another disadvantage of the CTs is the occurrence of dead spots which result in dropped calls.

There have been attempts to merge the two telephone systems with some success. Primarily, the known systems require a land line or wire connection between the LLT, the interface box and the CT. This limitation while possibly being unduly costly also limits the location of the CT. This may result in the CT not being located in the area of absolute best reception.

The instant invention has as its primary object overcoming these two discrete disadvantages.

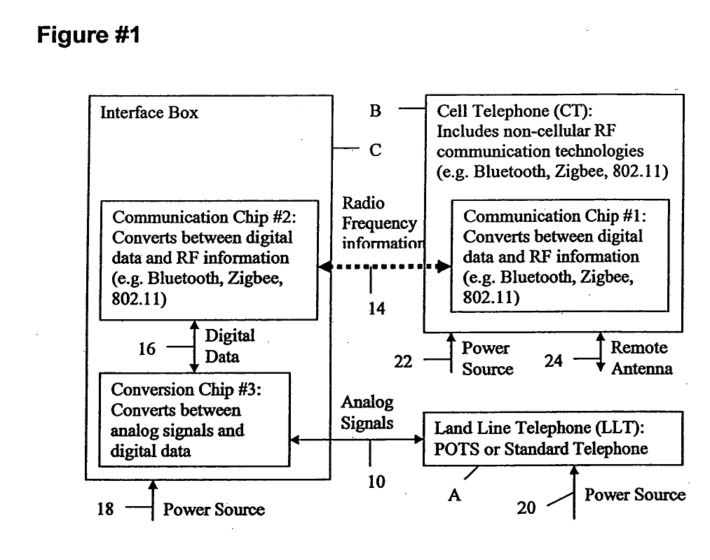

Turning now to the drawing. FIG. 1 shows a diagram depicting the various components of the invention or arranged.

Box or station A represents the standard land line telephone (LLT) system which may include any number of jacks arranged about the premises providing an equal number of connections with the LLT's. As is usual, the LLTs operate by way of analog signals which are not compatible with the digital data or radio frequency information, the latter two which operates with the Cellular Telephone (CT) systems.

To accommodate the various signals, the systems of the invention provides interface box C which is interconnected with the station A representing the LLT system by way of land line 10.

Interface box C comprises a conversion chip 3 which is connected with communication chip 2 by land line or connector 16. Also chip 3 is connected with station A through land line 10.

Chip 3 is operative to receive an analog signal from station A, convert that signal to a digital signal and send the digital signal to chip 2 by land line or physical connection 16.

Conversely, digital data from chip 2 is sent by line 16 to chip 3 which converts it to analog data and sends it by way of line 10 to station A.

Chip 3 is also programmed to generate an analog signal representing a dial tone when an LLT is taken off the hook or is activated. Chip 3 is also programmed to convert analog numerical signals generated and sent from station A into digital data numerical designations and to transmit that data to chip 2.

Chip 3 is further programmed to senses the termination of a LLT call and generates the digital data which is passed to chip 2.

Chip 2 is programmed to receive digital data representing various functions as referred to above from chip 3, to convert this digital data into radio frequency information and to transmit the RF information to B. Chip 2 is also programmed receive RF information from B, convert that information into digital data and sends the digital data to chip 3. This information includes on-off hook, dialing instructions, numbers and voice information.

Chip 2 acts to convert all RF information transmitted from chip 1 and sends that converted information on to chip 3 which then transmits the information as analog signals to station A. This information includes on-off hook, dialing instructions, numbers and voice information.

Station B may comprise any of the many standard CT models which include an additional chip which is adapted to receive external information, specifically carried by radio frequencies and converts that information into cellular telephone commands, instructions and/or data.

Chip 1 operates to receive signals from the CT, convert those signals into RF information and to transmit that RF information to chip 2. Also chip 1 receives RF information from chip 2, converts that information into CT commands, instructions and/or data.

The communication between chip 1 and chip 2 is non-physical or airborne. This allows total freedom in selecting the location of the CT such as to isolated positions within the building of use. These locations may even be external of the building. This allows for the selected position to provide optimum reception. It further allows for the location to be easily changed due to circumstance in which the position of the optimum reception changes. Furthermore, this is a much more economical arrangement because land lines do not have to be provided between interface box B and the CT which can be expensive depending on the location of the CT.

Station A comprises standard land line telephone equipment to include the lines, jacks and telephones. Interface box C includes conversation chip 3 and communication chip 2. Chip 3 may comprise of a microprocessor, analog to digital converter and digital to analog converter which are programmable to operate in the manner as earlier described. These chips are readily available. Chip 2 may comprise the Bluetooth, ZigBee, 802.11 or other known systems which are preprogrammed to operate in the manner previously described.

Station B comprises of off the shelve technology.

In operation, when a call comes to station B, the signal moves through the CT and out chip 1 as RF information to chip 2 of interface box C. Chip 2 converts the RF information into digital data which is passes to chip 3. Chip 3 converts the digital data into analog signals which are sent to station A causing the LLT to ring. Chip 3 will detect when the LLT is removed from the hook, sends digital data to chip 2 which converts the data into RF information which is sent to station B causing the CT to activate for voice communication.

Termination of the call is sensed by chip 3 which sends a signal through chip 2 to chip 1 deactivating the CT.

When a call is to be sent from station A, the LLT is removed from its hook which causes chip 3 to send an analog signal in the form of a dial tone. The LLT is activated to send analog signals representing numerical data to chip 3. Chip 3 converts these signals into digital data which is sent to chip 2. Chip 2 converts this data into RF information and sends the information to the CT. Chip 3 is programmed to detect when a valid phone number has been entered. When chip 3 detects a valid number, it sends a signal to chip 2 which is converted to RF information and sent to CT initiating the call. If the call is completed, chip 3 receives a signal from chip 1 and chip 2 in the manner described which activates voice communication between the CT and LLT. Upon termination of the call by the LLT, an analog signal is sent to chip 3 which it converts to digital data for chip 2 which converts it to RF information for chip 1 which deactivated the CT. Upon termination of the call by the outside connection, the CT will end the call and signal chip 2 which will signal chip 3 to activate a analog signal representation a dial tone for the LLT.

When a call is established, voice data is received by the CT, converted by chip 1 to RF information, sent to chip 2 converted into digital data, forwarded to chip 3, converted analog signals and sent to LLT. Conversely, analog voice data is sent from the LLT to chip 3, converted to digital data and sent to chip 2, converted to RF information and sent to chip 1 which forwards the information onto the CT.

Station B may include an independent power source indicated at 22 and an antenna 24 for improved reception, Station A & C may also include power sources as indicated at 18 and 20.

It is to be noted that the form of the present invention shown and disclosed is to be taken as a preferred embodiment of the invention. Various changes in the shape, size and arrangements of parts may be resorted to without departing from the spirit of the invention or the scope of the subjoined claims.

What is claimed:

1. A hybrid telephone system comprising:
a cellular telephone (CT) which includes a communication chip which receives and converts CT data to radio frequency signals (RF) and which receives and converts RF signals to CT data, said CT being mounted in a stationary position;
a second communication chip spaced from said communication chip, said second communication chip being capable of receiving and converting said RF signals to digital data and receiving and converting digital data to RF Signals;
a conversion chip, interconnected with the said second communication chip and with land line telephone (LLT), said conversion chip being capable of receiving and converting digital data to analog signals and of receiving and converting analog signals to digital data;
said LLT is capable of receiving and sending analog signals; whereby,
said RF signals sent by the said communication chip to said second communication chip are converted into digital data and sent to said conversion chip, said conversion chip converting said digital signal into said analog signal which is sent to said LLT and said analog signals sent by said LLT to said conversion chip are converted into said digital data and sent to said second communications chip, said second communication chip converts said digital data to said RF signals which are sent to said communication chip of said CT.

2. The hybrid telephone system of claim 1; wherein,
said conversion chip is operative to generate an analog signal representing a dial tone when the said LLP is off hook.

3. The hybrid telephone system of claim 1; wherein,
said conversion chip is operative to convert an analog signal of numerical designation into digital data and send said digital data to said second communications chip.

4. The hybrid telephone system of claim 3; wherein,
said second communications chip converts said digital data into RF signals which are sent to said communications chip.

5. The hybrid telephone system of claim 1; wherein,
said conversion chip senses completion of a dial number and signals CT to make call.

6. The hybrid telephone system of claim 1; wherein,
an incoming call passes through the said communications chip to the said second communication chip and into the said conversion chip which generates an said analog signal to ring the said LLP.

7. The hybrid telephone system of claim 1; wherein, an incoming call passes through the said communications chip to the said second communication chip and into the said conversion chip which generates an said analog signal to ring the said LLP.

8. The hybrid telephone system comprising:
a cellular telephone (CT) including a first communication chip, and interface box and a land line telephone (LLT);
said CT being operative to receive and send radio frequency signals and said LLT being operative to receive and send analog signals;
said interface box including second and third chips which are operative to receive and send land line analog signals with said LLT and to receive and send radio frequency signals with said CT; whereby,
said CT may be located a distance separated from the LLT.

9. The hybrid telephone system of claim 8; wherein,
said third chip of said interface box is capable of connecting analog signals which include voice signals, numerical signals, off hook signals and on hook signals to digital data and converting digital data voice signals and digital data concession signals to analog signals.

10. A method of operation a hybrid telephone system including:
providing a cellular telephone (CT) having a first communication chip, an interface box and a land line telephone (LLT);
providing that said CT operate with radio frequency signals and that said LLT operate with analog signals;
providing that said interface box be operative to receive said radio frequency signals from said CT; convert said radio frequency signals to analog signals and send said analog signals to said LLT, further providing that said interface box be operative to receive said analog signals from said LLT, convert said analog signals to radio frequency signals to send said radio frequency signals to said CT; whereby,
said hybrid telephone operates with both analog and radio frequency signals.
